(19) United States
(12) Patent Application Publication
(10) Pub. No.: US 2026/0089099 A1
(43) Pub. Date: Mar. 26, 2026

(54) DATA PACKET PROCESSING USING DYNAMIC ARGUMENT ASSIGNMENT

(71) Applicant: MELLANOX TECHNOLOGIES, LTD., Yokneam (IL)

(72) Inventors: Avi URMAN, Yokneam (IL); Ariel SHAHAR, Jerusalem (IL); Najeeb DARAWSHY, Iksal (IL)

(73) Assignee: MELLANOX TECHNOLOGIES, LTD., Yokneam (IL)

(21) Appl. No.: 18/894,252

(22) Filed: Sep. 24, 2024

(51) Int. Cl. H04L 45/745; H04L 69/22

(52) U.S. Cl. CPC H04L 45/745; H04L 69/22; H04L 2212/00

(57) ABSTRACT

Methods, apparatuses, and computer program products are provided for processing data packets. The method includes receiving a data packet. The method further includes matching the data packet to a steering table entry (STE), wherein the STE includes arguments associated with processing the data packet and a pointer that points to an executable sequence. The method further includes dynamically configuring the executable sequence to process the data packet using at least the arguments. The method further includes executing the executable sequence to process the data packet.

### TECHNOLOGICAL FIELD

Example embodiments of the present disclosure relate generally to packet steering in network systems.

### BACKGROUND

Modern networking solutions must handle voluminous data packet transfers. As the demand for high-speed data packet transmission increases, so too the need for high-speed decisioning associated with each packet received. Applicant has identified numerous deficiencies and problems associated with conventional methods of data packet processing. Through applied effort, ingenuity, and innovation, many of these identified problems have been solved by developing solutions that are included in embodiments of the present disclosure, many examples of which are described in detail herein.

### BRIEF SUMMARY

Embodiments of the present disclosure are directed to data packet processing. A need exists to quickly process data packets due to the high volume of packets transmitted in modern networking environments. As such, embodiments of the invention described herein may include dynamically configuring an executable sequence to compress actions performed on data packets. In this way, embodiments of the invention may centralize processing commands (e.g., actions) associated with steering data packets due to the duplicative nature of the actions.

In some embodiments, a method for processing data packets is provided. The method may initially receive a data packet and match the data packet to a steering table entry (STE), wherein the STE includes arguments associated with processing the data packet and a pointer that points to an executable sequence. Further, the method may include dynamically configuring the executable sequence to process the data packet using at least the arguments. Further still, the method may include executing the executable sequence to process the data packet.

In some embodiments, the data packet may include a header. Further, the STE may include a tag including a set of criteria and a match parameter. In this way, matching the data packet to the STE includes using the match parameter to identify one or more segments of the header and comparing the segments to the set of criteria.

In some embodiments, the STE may include a match size, indicating the size of the tag. In some embodiments, the match size may be equivalent to 4 DWORDS.

In some embodiments, the STE may further include a miss pointer configured to identify an alternate STE that may include alternate arguments associated with processing the data packet. In this way, the method may further include matching the data packet to the alternate STE, dynamically configuring the executable sequence to process the data packet using the alternate arguments, and executing the executable sequence to process the data packet.

In some embodiments, the STE may further include a sequence including a sequence of executable actions and a sequence pointer used to identify the sequence. In some embodiments, the method may further include receiving one or more inputs from at least one of the arguments or the sequence identified by the sequence pointer, and dynamically configuring the executable sequence using the sequence of executable actions and the one or more inputs.

In some embodiments, the method may further include parsing the data packet into discrete portions and storing the discrete portions of the data packet in registers.

In some embodiments, the STE may include a sequence pointer. In this way, the method may further include fetching a sequence identified by the sequence pointer, where the sequence includes a sequence of executable actions. Further, the method may include receiving one or more inputs from at least one of the registers, the arguments, or the sequence. Further still, the method may include dynamically configuring the executable sequence using the sequence of executable actions and the one or more inputs.

In some embodiments, a network adapter to process data packets is provided. The network adapter may include a network interface operatively coupled to a communication network and packet processing circuitry operatively coupled to the network interface. Upon receipt of a data packet via the network interface, the packet processing circuitry may be configured to match the data packet to a STE that includes arguments associated with processing the data packet and a pointer that points to an executable sequence. Further, the packet processing circuitry may dynamically configure the executable sequence to process the data packet using at least the arguments and execute the executable sequence to process the data packet.

In some embodiments, the data packet may include a header. Further, the STE may include a tag that includes a set of criteria, and a match parameter. The packet processing circuitry may be configured to match the data packet to the STE using the match parameter to identify one or more segments of the header and comparing the one or more segments to the set of criteria.

In some embodiments, the STE may include a match size indicating a size of the tag.

In some embodiments, the STE may further include a miss pointer configured to identify an alternate STE including alternate arguments associated with processing the data packet. Further, the packet processing circuitry may be configured to match the data packet to the alternate STE, dynamically configure the executable sequence to process the data packet using at least the alternate arguments, and execute the executable sequence to process the data packet.

In some embodiments, the STE may further include a sequence that includes a sequence of executable actions and a sequence pointer used to identify the sequence. The packet processing circuitry may be configured to receive one or more inputs from at least one of the arguments or the sequence identified by the sequence pointer and dynamically configure the executable sequence using the sequence of executable actions and the one or more inputs.

In some embodiments, the packet processing circuitry may be configured to parse the data packet into discrete portions and store the discrete portions into registers.

In some embodiments, the STE may further include a sequence pointer. The packet processing circuitry may be further configured to fetch a sequence identified by the sequence pointer, receive one or more inputs from at least the registers, the arguments, or the sequence, and dynamically configure the executable sequence using the sequence of executable actions and the inputs.

In some embodiments, a computer program product for processing data packets is provided. The computer program product may include at least one non-transitory computer-readable storage medium storing program instructions that may be executed. Upon execution, the instructions may cause an apparatus to receive a data packet, match the data packet to a STE that includes arguments associated with processing the data packet and a pointer that points to an executable sequence, dynamically configure the executable sequence to process the data packet using at least the arguments, and execute the executable sequence to process the data packet.

In some embodiments, the data packet may include a header. Further, the STE may include a tag including a set of criteria and a match parameter. The program instructions, when executed, may cause the apparatus to match the data packet to the STE using the match parameter to identify one or more segments of the header and comparing the one or more segments to the set of criteria.

In some embodiments, the STE further includes a match size indicating the size of the tag.

In some embodiments, the STE may further include a miss pointer configured to identify an alternate STE, wherein the alternate STE includes alternate arguments associated with processing the data packet. Further, the program instructions, when executed, may cause the apparatus to match the data packet to the alternate STE, dynamically configure the executable sequence to process the data packet using at least the alternate arguments, and execute the executable sequence to process the data packet.

In some embodiments, the STE may further include a sequence, wherein the sequence includes a sequence of executable actions and a sequence pointer used to identify the sequence. Further, the program instructions, when executed, may cause the apparatus to receive one or more inputs from at least one of the arguments or the sequence identified by the sequence pointer, and dynamically configure the executable sequence using the sequence of executable actions and the one or more inputs.

In some embodiments, the program instructions, when executed, may cause the apparatus to parse the data packet into discrete portions and store the discrete portions of the data packet in registers.

In some embodiments, the STE further includes a sequence pointer, wherein the program instructions, when executed, may cause the apparatus to fetch a sequence identified by the sequence pointer, receive one or more inputs from at least one of the registers, the arguments, or the sequence, and dynamically configure the executable sequence using the sequence of executable actions and the one or more inputs.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 is a schematic illustration of the location of the data packet processor in accordance with some embodiments described herein;

FIG. 2 is a schematic illustration of an example network device in accordance with some embodiments described herein;

FIG. 3 is a flowchart illustrating a method of data packet processing using dynamic argument assignment in accordance with some embodiments described herein; and

FIG. 4 is a schematic illustration of input sources as they relate to an executable sequence in accordance with some embodiments described herein.

### DETAILED DESCRIPTION

Embodiments of the present disclosure now will be described more fully hereinafter with reference to the accompanying drawings in which some but not all embodiments are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout. As used herein, terms such as “front,” “rear,” “top,” “bottom,” “side,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Furthermore, when it is said herein that something is “based on” something else, it may be based on one or more other things as well. In other words, unless expressly indicated otherwise, as used herein “based on” means “based at least in part on” or “based at least partially on.” Also, as used herein, the term “or” is intended to be inclusive when used in a series and may be used interchangeably with “and/or,” unless explicitly stated otherwise (e.g., if used in combination with “either” or “only one of”). No element, act, or instruction used herein should be construed as critical or essential unless explicitly described as such.

A data packet is a block of data transmitted across a network, wherein the block of data may be a small segment of a larger message. Data transferred over a network is sent via data packets. In this way, each data packet forms part of a complete message and carries pertinent information that helps identify the sending device and destination device (e.g., receiving device), as well as other information for processing the data packet. When data packets are received at the destination device, the data packets may be recombined by the destination device to form a usable message. A number of challenges relating to data processing involve the steering of data packets. Data packet steering refers to the decisioning associated with where to deliver a packet and which actions to perform on the data in the packet, once received, to effect the recombination or to gain other benefits from modifying the packet.

Data packets may take different forms (raw Ethernet Protocol, Ethernet Control Message Protocol, User Datagram Protocol, Transmission Control Protocol, and/or the like). The basic structure of a data packet, however, typically includes three parts: the header, the payload, and the trailer. The header contains instructions about the data carried by the packet, which may include fields such as a version, Internet Header Length, Identification, Total Length, Time to Live (TTL), Source Address, and/or Destination Address, among others. The different forms of data packets may contain different fields in the header that provide metadata associated with the packet. The payload (e.g., body) of the data packet may include the actual data the packet is delivering to the destination. At the destination device, the payloads of the received data packets may be assembled to create the message (e.g., a video, a picture, an application, and/or the like). The trailer indicates the end of the data packet.

A steering table is a part of a network device's configuration or network infrastructure. A steering table is used to manage and guide the flow of data packets in a network. The steering table may also be referred to as a forwarding table or a routing table, and may be stored in network devices, routers, switches, a central processing unit (CPU), a data processing unit (DPU), a graphics processing unit (GPU), or the like. The steering table may use various criteria such as destination addresses, source addresses, protocol types, and the like to determine how data packets should be handled. A steering table may contain individual rows and columns that populate the table. Each entry in the table may include specific conditions and corresponding actions if those conditions are met. For example, a steering table may include multiple fields that state rules and/or criteria that dictate how a packet should be handled, based on the header information or the payload of the packet.

An entry within the steering table is known as a steering table entry (STE). Each STE may be associated with specific functions, such as action executions, matching functions, updating or optimizing operations, and the like. The STE may be used in traffic steering to determine how packets should be treated after being received in the network device so they will be ready for their next stage of handling. The handling instructions for the packet may include information on how to deliver the packet to a specific destination, the order in which the packet should be assembled, modifications to be made to the packet, security checks to be performed, and/or the like. The packets, and their associated actions, are typically handled individually and independently of other packets and/or their actions. In this way, the data packets are processed on an individual basis, despite some data packets requiring that similar, if not identical, actions be performed.

In the realm of high-performance computing environments, the high-speed transmission of data across networks presents significant challenges. Some of these challenges relate to the steering of data packets. As noted above, data packet steering involves the decisioning associated with where an incoming packet should be delivered and which actions to perform on the headers or on the data in a packet being either transmitted or received. Conventionally, steering is accomplished by first reading a data packet's header information and then deciding what actions to take based on the given rules. This becomes resource intensive and inefficient when a network has to process the same or similar actions for a large number of data packets.

Network devices, such as Network Interface Cards (NICs), play a crucial role in augmenting network efficiency by offloading tasks traditionally handled by software in the host processor, thereby conserving Central Processing Unit (CPU) cycles. A NIC is a hardware component that connects a computer to a network environment. The NIC facilitates network traffic (e.g., data packet) engineering, transmission, and handling. The NIC also supports input/output interrupt, direct-memory access interfaces, and the like. The NIC may provide a computer with a dedicated, full-time connection to a network by providing a physical layer required for communications. For example, a NIC may take the form of a data processing unit (DPU) to facilitate traffic management on the network, increase security, and enhance storage processing capabilities. A specific example of a DPU that may be used is an Nvidia BlueField® processor, which may include cloud infrastructure processing that frees host CPU cores to manage application operations as opposed to infrastructure tasks. The communications may be routed through wired connections (Ethernet), wireless connections (e.g., Wi-Fi), or some combination thereof.

In systems with multiple users, such as servers hosting virtual machines, the NICs must handle packets intended for or sourced from various recipients. To this end, the NICs of a networking environment perform the steering of the data packets to ensure that the data packets are processed correctly. However, in a high-performance computing environment, the rate at which data packets should be processed can become extremely high, which can conflict with network latency requirements, among other requirements. In such high-performance computing environments, an increase in bandwidth causes an increase in the rate at which packets are sent or received, necessitating quicker steering decisions. Further, a host with multiple users (e.g., virtual machines) can receive a diverse array of packets, each potentially requiring unique processing. To efficiently steer and process data packets, the network relies on databases. These databases may be used to identify the packet type, identify the packet owner, dictate the specific actions to be executed on the packet, or the like. Given the high volume of packets and the speed at which they must be processed, accessing extensive databases for each packet can become a significant bottleneck. To address these concerns, embodiments of the present invention provide apparatuses and methods for compressing or densely structuring databases to allow for rapid lookup and decision-making regarding packet steering and processing.

The present disclosure may, by way of dynamic argument assignment, compress the actions taken to process multiple data packets associated with the same or similar processing actions, as described herein. While conventional solutions process data packet actions on an individual basis, the present disclosure allows for the reduction of the resource overhead via dynamically configuring executable sequences that can be used to process multiple data packets associated with the same or similar processing actions. In this regard, dynamically configuring an executable sequence may comprise creating an executable sequence in real time based on characteristics of the incoming data packets using pre-existing inputs, as described in greater detail herein. For example, if a data packet is received that has processing actions similar and/or identical to another data packet, embodiments of the invention provide that an executable sequence may be built using stored inputs, and the executable sequence may be used to process subsequent data packets having the same/similar characteristics. In this way, the resources required for processing the data packets may be reduced as compared to conventional operations that process data packets without regard to the similarity of actions among the data packets.

Further, dynamically configuring the executable sequences as described herein allows executable sequences to be adjusted based on the received data packets to enable those executable sequences to process the subsequent data packets. The ability to configure an executable sequence based on an incoming stream of data packets may compress the actions taken on the incoming data packets by reducing duplicative data packet processing actions, thereby promoting effective use of the data packet processing resources.

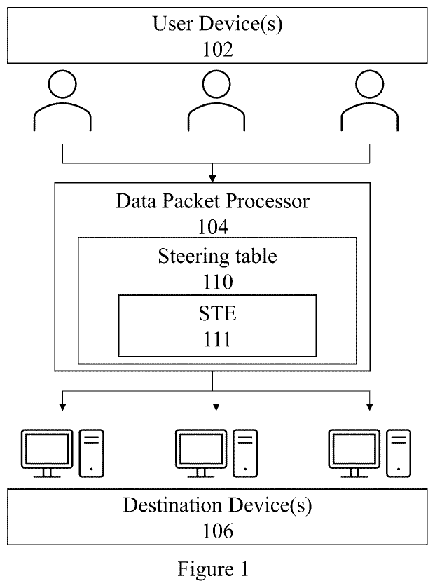

With reference to the figures, data packet processing using dynamic argument assignment is illustrated and described below. As shown in FIG. 1, in some embodiments, a user may interact with a user device (e.g., user device(s) 102) to transmit a data packet to a data packet processor 104. The user device 102 may be a computer, a server, a web server, database server, file server, laptop, desktop, workstation, auxiliary network device, internet-of-things device, electronic kiosk, mainframe, and/or the like. The data packet may be processed by the data packet processor 104 and subsequently transferred to a destination device 106. The destination device 106 may be the final destination or an intermediary destination for the data packet. In this way, data packet processing within the data packet processor may cause distribution of the data packets received from the user device 102 to the corresponding destination device 106. The destination device 106 may be a server, a web server, database server, file server, laptop, desktop, workstation, auxiliary network device, internet-of-things device, electronic kiosk, mainframe, and/or the like. In some cases, the data packet processor 104 may be part of the user device 102, whereas in other cases the data packet processor may be part of the destination device 106. In still other cases, the data packet processor 104 may be part of a different device or circuitry that is in communication with the user device 102 and/or the destination device 106, such as a network device 120. In some embodiments, the network device 120 may include a network adapter, a NIC, a switch, or the like. In some embodiments, the data packet processor 104, the network device 120, or the processor 105 may include, but is not limited to, a data processing unit (DPU), such as the Nvidia BlueField® DPU, for example. Further, in some embodiments, the network device 120 and/or the data packet processor 104 may include the processor 105. For example, the processor 105 may be the processor of the network device 120 and/or the data packet processor 104. Further still, in some embodiments, the network device may include components such as a NIC, a network switch, a network gateway, or the like. In other words, the methods, actions, and processes described herein may be implemented using components such as a network switch in some embodiments.

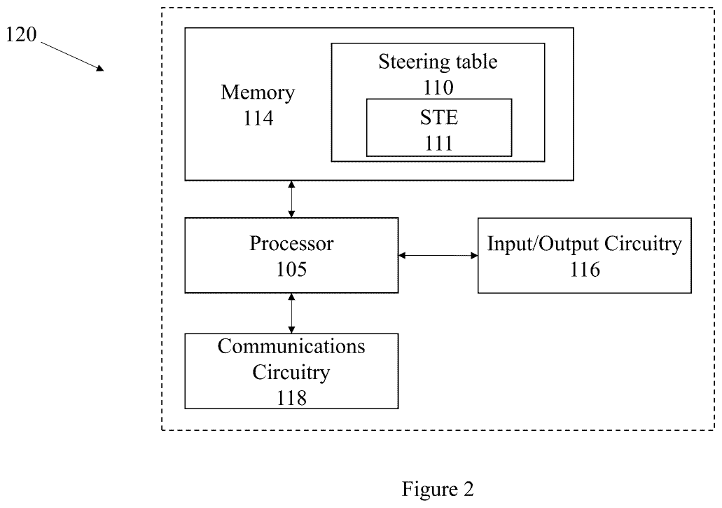

FIG. 2 illustrates a schematic illustration of example circuitry for processing data packets. For ease of explanation, FIG. 2 shows the circuitry as being embodied by a network device 120; however, some or all of the circuitry may be included in the user device 102 and/or the destination device 106 and/or may be embodied by a separate device in communication with the user device 102 and/or the destination device 106, such as in a case where no network device is provided. As shown in FIG. 2, the circuitry may include the processor 105, a memory 114, input/output circuitry 116, and communications circuitry 118. Further, in some embodiments, and as shown in FIG. 2, the circuitry may include a steering table 110.

Although the term “circuitry” as used herein with respect to components 105, 114-120 is described in some cases using functional language, it should be understood that the particular implementations necessarily include the use of particular hardware configured to perform the functions associated with the respective circuitry as described herein. It should also be understood that certain of these components 105, 114-120 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the circuitry shown in FIG. 2 may be housed together, while other components are housed separately. While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the circuitry may provide or supplement the functionality of particular circuitry. For example, the data packet processor 104 may provide processing functionality, the memory 114 may provide storage functionality, the communications circuitry 118 may provide network interface functionality, and the like.

In some embodiments, the processor 105 (and/or co-processor or any other processing circuitry assisting or otherwise associated with the processor) may be in communication with the memory 114 via a bus for passing information among components of the circuitry. The memory 114 may be non-transitory and may include, for example, one or more volatile and/or non-volatile memories, or some combination thereof. In other words, for example, the memory 114 may be an electronic storage device (e.g., a non-transitory computer readable storage medium). The memory 114 may be configured to store information, data, content, applications, instructions, or the like, for enabling an apparatus, e.g., the user device 102 or the destination device 106, to carry out various functions in accordance with example embodiments of the present disclosure. The memory 114 may further be configured to provide functionality for handling incoming data packets, such as buffering, caching, firmware configurations, and the like. As such, the memory 114 may improve the network adapter's ability to manage the flow of incoming data packets.

Additionally, or alternatively, in some embodiments, the processor 105 may use the memory 114 to store or access previously collected information. For example, in some implementations, the processor 105 may include hardware, software, firmware, and/or a combination thereof, that interacts with the memory 114 to send, retrieve, update, and/or store data. For example, an STE may be stored on the memory 114 and accessed by the processor 105 when appropriate. Further, the steering table may reside on any memory (e.g., the memory 114) that is accessible to the processor 105, the NIC, or the like. In this regard, the steering table may reside on the die of the NIC, in the host memory, or any other accessible memory 114. In another example, a register and the items associated with the register may also be stored in the memory 114, as will be described in greater detail below.

Although illustrated in FIG. 2 as a single memory, the memory 114 may comprise a plurality of memory components. The plurality of memory components may be embodied on a single computing device or distributed across a plurality of computing devices. In various embodiments, the memory 114 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 114 may be configured to store information, data, applications, instructions, or the like for enabling the device (e.g., the user device 102 or the destination device 106, etc.) to carry out various functions in accordance with example embodiments discussed herein. For example, in at least some embodiments, the memory 114 may be configured to buffer data for processing by the processor 105. Additionally, or alternatively, in at least some embodiments, the memory 114 may be configured to store program instructions for execution by the processor 105. The memory 114 may store information in the form of static and/or dynamic information. This stored information may be stored and/or used by the processor 105 or other components during the course of performing its functionalities.

The processor 105 may be embodied in a number of different ways and may, for example, include one or more processing devices configured to perform independently. Additionally, or alternatively, the processor 105 may include one or more processors configured in tandem via a bus to enable independent execution of instructions, pipelining, and/or multithreading. The processor 105 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. For example, the processor 105 may include a DPU, a CPU, a GPU, a network adapter, a switch, or the like. Further, the data packet processor 104 as shown in FIG. 1 may include the processor 105. In this way, the data packet processor 104 may include the variations of the processor 105 as described herein. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, the processor 105 may include a plurality of processors. The plurality of processors may be embodied on a single computing device (e.g., the network device 120 as shown in FIG. 2, the user device 102, or the destination device 106) or may be distributed across a plurality of such devices collectively. The plurality of processors may be in operative communication with each other and may be collectively configured to perform one or more functionalities of the circuitry (e.g., the network device 120 as shown in FIG. 2, the user device 102, or the destination device 106) as described herein.

In an example embodiment, the processor 105 may be configured to execute instructions stored in the memory 114 or otherwise accessible to the processor 105. Alternatively, or additionally, the processor 105 may be configured to execute hard-coded functionality. As such, whether configured by hardware or software methods, or by a combination thereof, the processor 105 may represent an entity (e.g., physically embodied in circuitry) capable of performing operations according to an embodiment of the present disclosure while configured accordingly. Alternatively, as another example, when the processor 105 is embodied as an executor of software instructions, the instructions may specifically configure the processor 105 to perform one or more algorithms and/or operations described herein when the instructions are executed. For example, these instructions, when executed by the processor 105, may cause the associated device (e.g., the data packet processor 104 as shown in FIG. 1, the network device 120 as shown in FIG. 2, the user device 102, or the destination device 106) to perform one or more of the functionalities thereof as described herein. Further, it is to be understood that the data packet processor 104 as shown in FIG. 1 may include at least some of the components and functionalities as described with reference to the network device 120 and/or the processor 105 as shown in FIG. 2. In this way, for example, when the functionalities of the processor 105 are described, it is to be understood that the data packet processor 104 may also perform the described functionalities. As will be described in greater detail below, the functionality of the processor 105 may include executing the executable sequence.

In some embodiments, the circuitry further includes input/output circuitry 116 that may, in turn, be in communication with the processor 105 to provide an audible, visual, mechanical, or other output and/or, in some embodiments, to receive an indication of an input from a user or another source. In that sense, the input/output circuitry 116 may include means for performing analog-to-digital and/or digital-to-analog data conversions. The input/output circuitry 116 may include support, for example, for a display, touchscreen, keyboard, mouse, image capturing device (e.g., a camera), microphone, and/or other input/output mechanisms. The input/output circuitry 116 may include a user interface and may include a web user interface, a mobile application, a kiosk, or the like.

The processor 105 and/or user interface circuitry comprising the processor 105 may be configured to control one or more functions of a display or one or more user interface elements through computer-program instructions (e.g., software and/or firmware) stored on a memory accessible to the processor 105 (e.g., the memory 114, and/or the like). In some embodiments, aspects of input/output circuitry 116 may be reduced as compared to embodiments where the circuitry may be implemented as an end-user machine or other type of device designed for complex user interactions. In some embodiments (like other components discussed herein), the input/output circuitry 116 may be eliminated from the associated device circuitry (e.g., the network device 120 as shown in FIG. 2, the user device 102, or the destination device 106). The input/output circuitry 116 may be in communication with memory 114, communications circuitry 118, and/or any other component(s), such as via a bus. Although more than one input/output circuitry and/or other component can be included, only one is shown in FIG. 2 to avoid overcomplicating the disclosure (e.g., as with the other components discussed herein).

The communications circuitry 118, in some embodiments, includes any means, such as a device or circuitry embodied in either hardware, software, firmware or a combination of hardware, software, and/or firmware, that is configured to receive and/or transmit data from/to a network and/or any other device, circuitry, or module associated therewith. In this regard, the communications circuitry 118 may include, for example, a network interface for enabling communications with a wired or wireless communication network. For example, in some embodiments, communications circuitry 118 may be configured to receive and/or transmit any data that may be stored by the memory 114 using any protocol that may be used for communications between computing devices. For example, the communications circuitry 118 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 118 may include circuitry for interacting with the antenna(s) to cause transmission of signals via the antenna(e) or to handle receipt of signals received via the antenna(e). These signals may be transmitted by the network device 120 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 118 may additionally or alternatively be in communication with the memory 114, the input/output circuitry 116, and/or any other component shown in FIG. 2, such as via a bus. The communication circuitry 118 may also be configured to receive and transmit information with the various components associated therewith. Further, the communication circuitry 118 may communicate with other devices having memory that holds information needed for processing data packets.

Further, the steering table 110 as shown in FIG. 2 may be used to determine how a packet is processed. The steering table 110 may include data that is used to match a data packet to a steering table entry (STE). For example, the packet data may include any field from the packet, including Media Access Control (MAC) addresses, Internet Protocol (IP) addresses, Transmission Control Point (TCP) data, version data, Internet Header Length, Identification, Total Length, Time to Live (TTL), Source Address, and/or the like. The actions may include, but are not limited to, transmitting the packet to a register, transmitting the packet to an STE, updating the data packet header information, updating the data packet payload information, creating an executable sequence, creating a sequence, or the like.

Accordingly, non-transitory computer readable storage media can be configured to store firmware, one or more application programs, and/or other software, which include instructions and/or other computer-readable program code portions that can be executed to direct operation of the associated device circuitry (e.g., the network device 120 as shown in FIG. 2, the user device 102, or the destination device 106) to implement various operations, including the examples described herein. As such, a series of computer-readable program code portions may be embodied in one or more computer-program products and can be used, with a device (e.g., the network device 120 as shown in FIG. 2, the user device 102, or the destination device 106), database, and/or other programmable apparatus, to produce the machine-implemented processes discussed herein. It is also noted that all or some of the information discussed herein can be based on data that is received, generated and/or maintained by one or more components of the associated device circuitry (e.g., the network device 120 as shown in FIG. 2, the user device 102, or the destination device 106). In some embodiments, one or more external systems (such as a remote cloud computing and/or data storage system) may also be leveraged to provide at least some of the functionality discussed herein.

Embodiments of the present disclosure provide methods, apparatuses, and computer program products for data packet processing using dynamic argument assignment. In apparatus embodiments of the disclosure, a network adapter may be used. The network adapter may include a network interface operatively coupled to a communication network. Further, the network adapter may include packet processing circuitry operatively coupled to the network interface, wherein, upon receipt of a data packet via the network interface, the packet processing circuitry may be configured to process the data packet, as discussed herein. In addition, a computer program product may be used to process data packets. The computer program product may include at least one non-transitory computer-readable storage medium storing instructions that, when executed, cause an apparatus to process a data packet, as discussed herein.

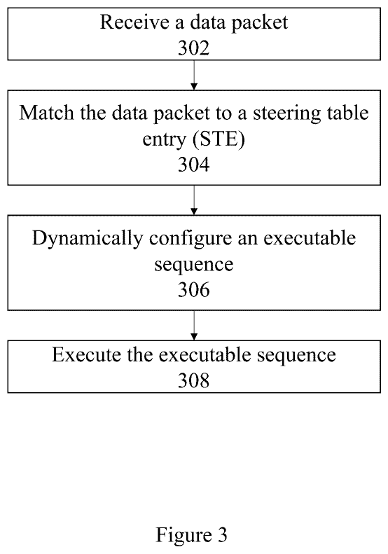

With reference to FIG. 3, a method for data packet processing may include the following steps. Initially, in some embodiments, the method may include receiving a data packet, as illustrated in block 302. In an example embodiment, a network device 120 may receive the data packet from a user device (e.g., the user device 102 of FIG. 1) via the communications circuitry 118, shown in FIG. 2.

In some embodiments, the method may include storing the packet in a register, such as a register defined in the memory 114 of the network device 120 in the example depicted in FIG. 2. The register may contain all or some of the information associated with the packet. In some embodiments, the method may further include parsing the data packet into discrete portions and storing the discrete portions of the data packet in registers. In this way, the packet may be parsed into sections and stored within the registers. The parsing of the packet may include separating the header and payload data, distinguishing certain header data from other header data, relating certain data to other data, and the like. For example, the data packet's header information and payload information may be stored in the register. In this way, the parsed data may be structured to allow for efficient referencing during the processing of the packet. For example, the parsed data, stored in the registers, may be referenced by the data packet processor 104 during the processing of the data packet.

As shown in block 304 of FIG. 3, the data packet may be matched to a steering table entry (STE), wherein the STE comprises arguments associated with processing the data packet. In some embodiments, the STE (e.g., STE 111 as shown in FIGS. 1 and 2) may be located in the steering table (e.g., the steering table 110). For example, in some embodiments, the data packet may include a header, and the STE 111, which may be stored in the memory 114 of the network device 120 shown in FIG. 2, may further include a tag comprising a set of criteria. The STE 111 may include a match parameter. Matching the data packet to the STE 111 may include using the match parameter to identify one or more segments of the header and comparing the one or more segments of the header to the set of criteria.

The STE 111 may include a data structure that determines the actions to be executed on each data packet. In this way, the STE 111 may provide instructions for the processor 105 on how to handle, route, and process incoming data packets. For example, as depicted in FIG. 2, a network device may use the STE 111 to determine where to route a data packet. The STE 111 may be based on specific protocols, such as IP, TCP, UDP, or specific fields in headers, such as UDP_sport or TCP_dport, or the like. The STE 111 may have varying size and complexity based on the network's infrastructure, requirements of the network, devices associated with the network, security features, and the like. For instance, in some embodiments, the STE 111 may have a fixed size, for example, of 64 bytes, and may contain information used to determine how to process a packet. The STE 111 may include a “tag” used for matching the STE 111 with packet headers and an action segment that lists specific actions to be executed on the packet.

The tag within the STE 111 may include a specific pattern or set of criteria used to identify packets that should be processed in a certain way. The tag may be compared with a corresponding portion of each incoming packet's header. The portion of the packet's header used for comparison may be defined by a “match parameter” located within the STE 111. The match parameter identifies which segment of the header of the packet should be used to compare with the tag. For example, the match parameter may identify the media access control (MAC) address segment of the data packet's header as the segment to be used for comparison. In this example, the tag of the STE 111 may be compared against the MAC address of the data packet to determine how the data packet should be handled.

In some embodiments, the STE 111 may include a match size, wherein the match size indicates a size of the tag. In this way, the match size may identify that the tag should be a certain size, such as, for example, 4 DWORDS. The match size may also identify the size of the corresponding header portion of the packet. Because the tag and the segment of the header must match to be considered a “hit,” the size of both should be equal. Therefore, the match size may indicate the size of the tag and the size of the segment of the header of the packet. For example, an STE 111 stored in memory 114 may include a particular match size. In this example, an incoming data packet's corresponding header portion may be compared with the STE's 111 match size.

In some embodiments, the STE 111 may further include a miss pointer, wherein the miss pointer identifies an alternate process in case of a mismatch between the data packet and the STE 111. The mismatch may indicate a mismatch between elements of the STE 111 and corresponding elements of the data packet (e.g., a “miss”). For example, if a data packet's MAC address does not match the corresponding MAC address in the STE 111, the miss pointer may be used.

Further, in some embodiments, the STE 111 may include a miss pointer configured to identify an alternate STE, wherein the alternate STE includes alternate arguments associated with processing the data packet. The alternate STE may, for example, be stored in the same memory 114 in which the STE 111 is stored or may reside in a different memory accessible to the data packet processor 104 shown in FIG. 1. In some embodiments, the miss pointer may point to an alternate STE that has a similar tag to the original STE's 111 tag. In this way, the miss pointer may include reasoning to understand the original STE's 111 tag and the data packet's specific segment and point to an alternate STE with similar matching conditions. In other words, the miss pointer may choose an alternate STE based on the original STE's 111 tag rather than randomly choosing an alternate STE. However, in some embodiments, the miss pointer may randomly choose an alternate STE. In some embodiments, the alternate STE, as identified by the miss pointer, may then reference its own tag, match parameter, and match size to determine a match between the alternate STE and the packet. Further still, in some embodiments, the method may include matching the data packet to the alternate STE. For example, the network device 120 may match the data packet to an alternate STE.

The STE 111 may also contain arguments that are to be given to a sequence (a list of instructions for how to process the data packet). Upon the data packet matching the STE 111 tag (e.g., a “hit”), a sequence pointer may be used to fetch a sequence of actions to execute. The fetched sequence may contain a set of executable actions that may be used to process the data packet, as described in greater detail below.

In some embodiments, the STE 111 may include a sequence pointer, wherein the method may further include fetching a sequence identified by the sequence pointer, wherein the sequence includes a sequence of executable actions. Further, in some embodiments, the method may further include receiving one or more inputs from at least one of the registers, the arguments, or inline with the sequence identified by the sequence pointer.

For instance, the sequence pointer may be located within the STE 111. When a match is identified (e.g., there is a match between the STE tag and the specific segment of the header), the sequence pointer may be used to fetch a sequence. The sequence pointer may point to a sequence that includes instructions on how to process the packet. In this way, the sequence may be a general sequence for an action that should be used to process the packet. For example, if a data packet ultimately needs a value of 16 added to its Time to Live (TTL) field, but another data packet needs a value of 17 added to its TTL field, the sequence may include an “add” function to the TTL field of both packets. Thus, the sequence may generally indicate an add function to the TTL but may not include the specific value needed to be added.

As illustrated in block 306 of FIG. 3, the method may include dynamically configuring an executable sequence. For example, the processor 105 of a network device 120 (shown in FIG. 2) may dynamically configure the executable sequence associated with a data packet by creating, modifying, reconfiguring, or otherwise building an executable sequence for processing a particular data packet. For example, once a sequence is fetched, the data packet processor 104, as shown in FIG. 1, may then build (e.g., dynamically configure) an executable sequence that may be used (e.g., sent to a processor of the destination device) to process the data packet. The inputs to the executable sequence may come from three sources: the fetched sequence itself (e.g., where the inputs are inline with the sequence), the STE 111, and/or the registers.

In cases where the inputs to the executable sequence come from the fetched sequence, the executable sequence may dynamically configure the executable sequence based on the sequence. In other words, data from the sequence may be used to configure the executable sequence. In other cases where the executable sequence is dynamically configured based on the STE, the data from the STE may be used to configure the executable sequence. Further, the executable sequence may be dynamically configured based on inputs from the registers. In this way, the data from the data packet that is stored in the registers may be used to dynamically configure the executable sequence.

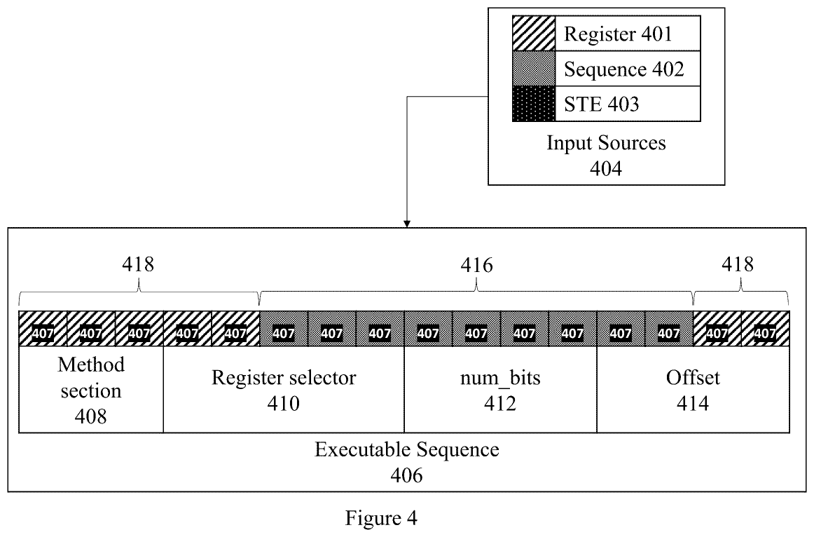

Further, in some embodiments, the method may further include dynamically configuring the executable sequence to process the data packet using the sequence identified by the sequence pointer. For example, a network device 120 may fetch the sequence stored in memory 114. The processor 105 may determine which sequence should be fetched. In this example, the processor 105 may then dynamically configure the executable sequence to process the data packet using the sequence identified by the sequence pointer. As shown in FIG. 4, the data packet processor 104 (shown in FIG. 1), may use the sequence 402 to dynamically configure the executable sequence 406.

For example, with reference to FIG. 4, the inputs 407 may have input sources 404 including the register 401, the fetched sequence 402, and/or the STE 403. The inputs 407 may be organized into one or more sections (e.g., islands), each potentially derived from up to two of the previously mentioned input sources 404. For example, an executable sequence 406 may include inputs 407 received from the register 401 and the fetched sequence 402.

The inputs 407 for dynamically configuring the executable sequence 406 may be organized into various sections of the executable sequence, including a method section 408, a register selector 410, a num_bits 412, and an offset 414. In some embodiments, the method section 408 of the executable sequence may indicate the input sources 404 from which the inputs 407 should be selected (e.g., up to two of the register 401, the fetched sequence 402, and/or the STE 403). The selected inputs 407 may be classified as primary bits 416 and secondary bits 418. For example, if an executable sequence's inputs 407 have two sources, one being the fetched sequence 402 and the other being the register 401, the inputs from the fetched sequence 402 may be grouped together with the inputs from the register 401. In this example, as shown in FIG. 4, the method section 408 of the executable sequence may indicate that inputs selected from the fetched sequence 402 should be classified as primary bits 416 and inputs selected from the register 401 should be classified as secondary bits 418.

Further, if applicable, the register selector 410 may select the appropriate location within the register 401 to be used as an input 407. In other words, in an instance in which one of the input sources is the register 401, the register selector 410 may indicate from which location in the register 401 the respective inputs 407 should be selected (e.g., from which line of the register the respective inputs should be selected).

The sections may be further constrained with respect to size (e.g., num_bits) and location at which the sections should start (e.g., offset). The num_bits 412 may indicate how many primary bits 416 should be selected from a given source. For instance, the fetched sequence 402 is indicated as the input source 404 for the primary bits 416, the num_bits 412 may dictate the number of primary bits 416 that should be taken from the fetched sequence 402. In the example shown in FIG. 4, the num_bits 412 may indicate that nine primary bits 416 should be selected.

The offset 414 may indicate the location within a line of the executable sequence 406 at which the primary bits 416 should be stored, with respect to the beginning position of the line. For example, as shown in FIG. 4, the offset 414 in the executable sequence 406 may indicate that the primary bits 416 should begin at the sixth location within the corresponding line of the executable sequence 406. After the primary bits 416 have been stored, the secondary bits 418 may be stored in the locations left open in the given line of the executable sequence 406, both ahead of and following the location of the primary bits 416, thereby creating “islands” of primary bits as depicted in FIG. 4.

In some embodiments, and in an instance in which an alternate STE is used, the method may include dynamically configuring the executable sequence to process the data packet using at least the alternate arguments. For example, the network device 120 may dynamically configure the executable sequence to process the data packet using at least the alternate arguments.

As illustrated in block 308 of FIG. 3, the method may include executing the executable sequence. For example, as described above, the executable sequence may contain specific instructions (e.g., arguments) to process the data packet. In this way, the executable sequence may be sent to a processor, such as a processor of the destination device 106 shown in the example of FIG. 1, wherein the processor may execute the executable sequence and perform the required actions on the data packet. The execution may thus include implementing the associated actions and corresponding arguments with respect to the packet. These actions may involve routing the packet to a specific destination, modifying the packet, performing security checks, and/or the like.

In an example, two data packets may be received by the network device. The first data packet may have a first source while the second data packet may have a second, different source. These data packets may be parsed and stored within registers (e.g., the registers shown in FIG. 4). The data packets may be matched to corresponding STEs, which may have arguments to add a value to the packets' headers. For example, the STE for the first packet may add 16 to the Time to Live (TTL) field of the first packet, while the STE for the second packet may add 17 to the TTL of the second packet. The sequences that are fetched may be an identical sequence (e.g., sequence 402 of FIG. 4) that contains an “add” action. Next, the executable sequences configured for the packets may receive inputs from up to two of three sources (e.g., input sources 404 of FIG. 4): the register, the STE, and/or the sequence. The inputs may be grouped and stored within the executable sequence, thereby configuring each executable sequence for processing a respective data packet. However, the inputs may alternatively be stored inside a register and therefore utilize the same executable sequence, each packet with the respective value in the register. Subsequently, the data packets and their executable sequences may be sent to a destination device (e.g., the destination device 106 shown in FIG. 1), where the executable sequences may be used by the processor of the destination device to process the respective data packets. For example, as a result of executing the executable sequences, actions may be performed on the respective data packets including routing of the packets to a specific destination, modifying the packets, performing security checks on the packets, or the like.

In some embodiments, the steps described herein may be carried out by a computer program product. The computer program product may be used to process data packets, wherein the computer program product includes at least on non-transitory computer-readable storage medium that stores program instructions. For example, with reference to FIG. 2, a network device 120 may include a computer program product stored in a memory 114, where the computer program product may be used to process data packets received by the network device. When these program instructions are executed, the computer program product may cause an apparatus (e.g., the network device 120) to carry out the steps mentioned above. In this way, the program instructions of the computer program product, when executed, may carry out the same or similar steps as the method described herein.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of any optical component or optoelectronic element. In addition, the methods described above may include fewer steps in some cases, while in other cases may include additional steps. Modifications to the steps of the method described above, in some cases, may be performed in any order and in any combination.

Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

What is claimed is:

1. A method for processing data packets comprising:
receiving a data packet;
matching the data packet to a steering table entry, wherein the steering table entry comprises arguments associated with processing the data packet and a pointer that points to an executable sequence;
dynamically configuring the executable sequence to process the data packet using at least the arguments; and
executing the executable sequence to process the data packet.

2. The method of claim 1, wherein the data packet comprises a header, wherein the steering table entry further comprises:
a tag comprising a set of criteria; and
a match parameter,
wherein matching the data packet to the steering table entry comprises using the match parameter to identify one or more segments of the header and comparing the one or more segments of the header to the set of criteria.

3. The method of claim 2, wherein the steering table entry further comprises a match size, wherein the match size indicates a size of the tag.

4. The method of claim 3, wherein the match size is 4 DWORDS.

5. The method of claim 2, wherein the steering table entry further comprises:
a miss pointer configured to identify an alternate steering table entry, wherein the alternate steering table entry comprises alternate arguments associated with processing the data packet,
wherein the method further comprises:
matching the data packet to the alternate steering table entry;
dynamically configuring the executable sequence to process the data packet using at least the alternate arguments; and
executing the executable sequence to process the data packet.

6. The method of claim 1, wherein the steering table entry further comprises:
a sequence, wherein the sequence comprises a sequence of executable actions; and
a sequence pointer used to identify the sequence;
wherein the method further comprises:
receiving one or more inputs from at least one of the arguments or the sequence identified by the sequence pointer; and
dynamically configuring the executable sequence using the sequence of executable actions and the one or more inputs.

7. The method of claim 1, wherein the method further comprises:
parsing the data packet into discrete portions; and
storing the discrete portions of the data packet in registers.

8. The method of claim 7, wherein the steering table entry further comprises a sequence pointer, wherein the method further comprises:
fetching a sequence identified by the sequence pointer, wherein the sequence comprises a sequence of executable actions;
receiving one or more inputs from at least one of the registers, the arguments, or the sequence identified by the sequence pointer; and
dynamically configuring the executable sequence using the sequence of executable actions and the one or more inputs.

9. A network device, comprising:
a network interface operatively coupled to a communication network; and
packet processing circuitry operatively coupled to the network interface, wherein, upon receipt of a data packet via the network interface, the packet processing circuitry is configured to:
match the data packet to a steering table entry, wherein the steering table entry comprises arguments associated with processing the data packet and a pointer that points to an executable sequence;
dynamically configure the executable sequence to process the data packet using at least the arguments; and
execute the executable sequence to process the data packet.

10. The network device of claim 9, wherein the data packet comprises a header, wherein the steering table entry further comprises:
a tag comprising a set of criteria; and
a match parameter,
wherein the packet processing circuitry is configured to match the data packet to the steering table entry by using the match parameter to identify one or more segments of the header and comparing the one or more segments of the header to the set of criteria.

11. The network device of claim 10, wherein the steering table entry further comprises a match size, wherein the match size indicates a size of the tag.

12. The network device of claim 10, wherein the steering table entry further comprises:
a miss pointer configured to identify an alternate steering table entry, wherein the alternate steering table entry comprises alternate arguments associated with processing the data packet,
wherein the packet processing circuitry is further configured to:
match the data packet to the alternate steering table entry;
dynamically configure the executable sequence to process the data packet using at least the alternate arguments; and
execute the executable sequence to process the data packet.

13. The network device of claim 9, wherein the steering table entry further comprises:
a sequence, wherein the sequence comprises a sequence of executable actions; and
a sequence pointer used to identify the sequence;
wherein the packet processing circuitry is further configured to:
receive one or more inputs from at least one of the arguments or the sequence identified by the sequence pointer; and
dynamically configure the executable sequence using the sequence of executable actions and the one or more inputs.

14. The network device of claim 9, wherein the packet processing circuitry is further configured to:
parse the data packet into discrete portions; and
store the discrete portions of the data packet in registers.

15. The network device of claim 14, wherein the steering table entry further comprises a sequence pointer, wherein the packet processing circuitry is further configured to:
fetch a sequence identified by the sequence pointer, wherein the sequence comprises a sequence of executable actions;
receive one or more inputs from at least one of the registers, the arguments, or the sequence identified by the sequence pointer; and
dynamically configure the executable sequence using the sequence of executable actions and the one or more inputs.

16. The network device of claim 9, wherein the network device further comprises:
a network adapter,
a data processing unit (DPU), or
a network switch.

17. A computer program product for processing data packets, the computer program product comprising at least one non-transitory computer-readable storage medium storing program instructions that, when executed, cause an apparatus to:
receiving a data packet;
matching the data packet to a steering table entry, wherein the steering table entry comprises arguments associated with processing the data packet and a pointer that points to an executable sequence;
dynamically configuring the executable sequence to process the data packet using at least the arguments; and
executing the executable sequence to process the data packet.

18. The computer program product of claim 17, wherein the data packet comprises a header, wherein the steering table entry further comprises:
a tag comprising a set of criteria; and
a match parameter,
wherein the program instructions, when executed, cause the apparatus to match the data packet to the steering table entry by using the match parameter to identify one or more segments of the header and comparing the one or more segments of the header to the set of criteria.

19. The computer program product of claim 18, wherein the steering table entry further comprises a match size, wherein the match size indicates a size of the tag.

20. The computer program product of claim 18, wherein the steering table entry further comprises:
a miss pointer configured to identify an alternate steering table entry, wherein the alternate steering table entry comprises alternate arguments associated with processing the data packet,
wherein the program instructions, when executed, cause the apparatus to:
match the data packet to the alternate steering table entry;
dynamically configure the executable sequence to process the data packet using at least the alternate arguments; and
execute the executable sequence to process the data packet.

21. The computer program product of claim 17, wherein the steering table entry further comprises:
a sequence, wherein the sequence comprises a sequence of executable actions; and
a sequence pointer used to identify the sequence;
wherein the program instructions, when executed, cause the apparatus to:
receive one or more inputs from at least one of the arguments or the sequence identified by the sequence pointer; and
dynamically configure the executable sequence using the sequence of executable actions and the one or more inputs.

22. The computer program product of claim 17, wherein the program instructions, when executed, cause the apparatus to:
parse the data packet into discrete portions; and
store the discrete portions of the data packet in registers.

23. The computer program product of claim 22, wherein the steering table entry further comprises a sequence pointer, wherein the program instructions, when executed, cause the apparatus to:
fetch a sequence identified by the sequence pointer, wherein the sequence comprises a sequence of executable actions;
receive one or more inputs from at least one of the registers, the arguments, or the sequence identified by the sequence pointer; and
dynamically configure the executable sequence using the sequence of executable actions and the one or more inputs.
